(19) United States
(12) Patent Application Publication
(10) Pub. No.: US 2019/0039613 A1
(43) Pub. Date: Feb. 7, 2019

(54) APPARATUS AND METHOD FOR CHANGING ROUTE OF VEHICLE BASED ON EMERGENCY VEHICLE

(71) Applicant: Samsung Electronics Co., Ltd., Suwon-si (KR)

(72) Inventors: DongWook LEE, Hwaseong-si (KR); Jahoo KOO, Seoul (KR); Jaewoo LEE, Hwaseong-si (KR); Dae Hyun JI, Hwaseong-si (KR)

(73) Assignee: Samsung Electronics Co., Ltd., Suwon-si (KR)

(21) Appl. No.: 15/996,931

(22) Filed: Jun. 4, 2018

(30) Foreign Application Priority Data
Aug. 4, 2017 (KR) 10-2017-0098939

(51) Int. Cl. B60W 30/095; B60W 50/14; G01C 21/36; G06K 9/00

(52) U.S. Cl. CPC B60W 30/0956; B60W 50/14; G01C 21/365; B60W 2420/42; B60W 2050/146; B60W 2420/52; G06K 9/00805

(57) ABSTRACT

A traveling route changing apparatus included in a vehicle determines whether an emergency vehicle is present among nearby vehicles located around the vehicle, tracks a movement of the emergency vehicle, determines whether to change a traveling route of the vehicle such that the emergency vehicle travels without being obstructed by the vehicle, generates candidate routes to change the traveling route of the vehicle, evaluate a risk involved with each of the candidate routes, and control the vehicle based on a candidate route having a lowest risk. Thus, the vehicle may travel along a selected candidate route, and the emergency vehicle may travel without being obstructed by the vehicle.

### CROSS-REFERENCE TO RELATED APPLICATIONS

This application claims the benefit under 35 USC § 119(a) of Korean Patent Application No. 10-2017-0098939 filed on Aug. 4, 2017, in the Korean Intellectual Property Office, the entire disclosure of which is incorporated herein by reference for all purposes.

### BACKGROUND

### 1. Field

The following description relates to an apparatus and method to generate or change a traveling route of the vehicle.

### 2. Description of Related Art

A collision between vehicles occurs frequently due to various reasons, such as, for example, carelessness of a driver and poor visibility. In addition, traffic accidents occur frequently due to a departure from a lane and a collision with other traveling vehicles, which may be caused by a lack of concentration of a driver and poor visibility especially when the driver drives a long distance, drives on a rainy day, or drives at night. To prevent such traffic accidents from occurring, an advanced driver assistance system (ADAS) may provide a warning of a collision, help a driver to avoid a collision, and control an operation of the vehicle. The ADAS may provide traveling information and risk information such that a driver may drive more conveniently and safely, or intervene in the driving of the vehicle to prevent accidents. To advance development of such an ADAS, research on a lane departure prevention system configured to actively steer a vehicle or to control a speed of the vehicle and an intelligent cruise control system has been conducted. Research has also been conducted in assistance information generating system such as, for example, a rear parking warning system, a lane departure warning system, and a drowsy driving warming system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a traveling route changing method, including detecting at least one nearby vehicle located around a vehicle, extracting an emergency vehicle among the at least one nearby vehicle, tracking a movement of the emergency vehicle, and determining whether to change a traveling route of the vehicle, in response to the movement of the emergency vehicle.

The extracting of the emergency vehicle may include extracting the emergency vehicle based on any one or any combination of a type of the at least one nearby vehicle, a state of the nearby vehicle, illumination on the nearby vehicle, whether a siren of the at least one nearby vehicle is activated, relative speeds of the at least one nearby vehicle and the vehicle, whether a horn of the at least one nearby vehicle is activated, an identifier on the at least one nearby vehicle, and a signal generated by the nearby vehicle.

The determining of whether to change the traveling route may include determining whether to change the traveling route based on whether the emergency vehicle changes to another lane or on a change in a distance between the emergency vehicle and the vehicle due to the movement of the emergency vehicle.

The method may include generating candidate routes for the vehicle to travel based on a movement of the at least one nearby vehicle, in response to a determination to change the traveling route, estimating, for each of the candidate routes, a collision probability of the vehicle colliding with the at least one nearby vehicle, and selecting, to be a new traveling route of the vehicle, a candidate route having a lowest collision probability, from among the candidate routes.

The method of claim 4, wherein the candidate routes may include a candidate route allowing the vehicle to move towards a border line of a lane on which the vehicle is travelling without changing to another lane.

In response to a candidate route where the vehicle changes to another lane being among the candidate routes, the estimating of the collision probability may include estimating the collision probability based on a nearby vehicle traveling on the another lane.

The method may include controlling the vehicle to travel along the selected traveling route.

The method may include generating a local map indicating a location of each of the at least one nearby vehicle and the vehicle, and a size of the local map is determined based on a speed of the vehicle.

The local map may be generated based on any one or any combination of the location of the at least one nearby vehicle, a speed of the at least one nearby vehicle, a speed of the vehicle, a lane along which the at least one nearby vehicle travels, or a type of a road on which the at least one nearby vehicle travels, a lane of the vehicle, a type of a road on which the vehicle travels, and a threshold distance from the vehicle.

The at least one nearby vehicle may include another vehicle within a threshold distance of the vehicle or within an area surrounding the vehicle.

In another general aspect, there is provided a traveling route changing apparatus, including a sensor configured to detect at least one nearby vehicle located around a vehicle, and a processor configured to extract an emergency vehicle among the at least one nearby vehicle, and determine whether to change a traveling route of the vehicle based on a movement of the emergency vehicle.

The processor may be configured to generate candidate routes for the vehicle to travel based on the movement of the at least one nearby vehicle, in response to a determination to change the traveling route, estimate, for each of the candidate routes, a collision probability of the vehicle colliding with the at least one nearby vehicle, and select one of the candidate routes, having a lowest collision probability, to be a new traveling route of the vehicle.

The candidate routes may include a candidate route allowing the vehicle to move towards a border line of a lane on which the vehicle is travelling without changing to another lane.

The processor may be configured to control the vehicle to travel along the selected traveling route.

The processor may be configured to generate a local map indicating a location of each of the at least one nearby vehicle and the vehicle, and a size of the local map is determined based on a speed of the vehicle.

In another general aspect, there is provided a traveling route changing method, including generating candidate routes for a vehicle to travel based on a movement of at least one nearby vehicle located around the vehicle, estimating, for each of the candidate routes, a collision probability of the vehicle colliding with the at least one nearby vehicle, and selecting one of the candidate routes to be a traveling route of the vehicle based on the collision probability of each of the candidate routes, wherein the candidate routes are generated based on a movement of an emergency vehicle located behind the vehicle among the at least one nearby vehicle.

The generating of the candidate routes may include generating a candidate route to not obstruct the movement of the emergency vehicle.

The method may include extracting the emergency vehicle among the at least one nearby vehicle based on any one or any combination of a type of a light source in the at least one nearby vehicle or whether the light source is activated.

The estimating of the collision probability may include determining a distance between the vehicle and the at least one nearby vehicle, in response to the vehicle travelling along a candidate route among the candidate routes.

The estimating of the collision probability may include determining a time to collision (TTC) between the vehicle and the at least one nearby vehicle, in response to the vehicle travelling along a candidate route among the candidate routes.

The method may include generating the candidate routes, in response to the emergency vehicle being located behind the vehicle and approaching the vehicle at a speed greater than or equal to a preset relative speed.

In another general aspect, there is provided a route changing apparatus including sensors configured to detect at least one nearby vehicle located around a vehicle, a head-up display (HUD), a memory configured to store map information and instructions, and a processor configured to execute the instructions to extract an emergency vehicle among the at least one nearby vehicle, determine whether to change a route of the vehicle, in response to a movement of the emergency vehicle, generate candidate routes for the vehicle, in response to a determination to change the route, estimate, for each of the candidate routes, a collision probability of the vehicle with the at least one nearby vehicle, select a candidate route having a lowest collision probability, from among the candidate routes, to be a new route for the vehicle, and output the new route through the HUD.

The sensors may include any one or any combination of global positioning system (GPS) sensor, image sensor, sound sensor, a light sensor, a radio detection and ranging (RADAR) sensor, a light detection and ranging (LiDAR or LADAR) sensor, and a sound navigation and ranging (SONAR) sensor.

The processor may be configured to generate a local map indicating a location of each of the at least one nearby vehicle and the vehicle, and the memory may be configured to store the local map and information associated with the route, wherein the information associated with the route may include any one or any combination of a road condition, a speed limit for the road, a number of lanes on the road, a speed limit on each lane of the lanes, a restriction on a type of a vehicle for the each lane, whether the each lane is controlled access, and whether the each lane is congested.

Other features and aspects will be apparent from the following detailed description, the drawings, and the claims.

### BRIEF DESCRIPTION OF THE DRAWINGS

FIG. 1 is a diagram illustrating an example of a change of a traveling route of a vehicle according to a traveling route changing method.

FIG. 2 is a diagram illustrating an example of a traveling route changing apparatus included in a vehicle.

FIGS. 3A through 3C are diagrams illustrating examples of an operation of a vehicle performing a traveling route changing method to determine whether to change a traveling route of the vehicle.

FIG. 4 is a diagram illustrating an example of an operation of a vehicle performing a traveling route changing method to change a traveling route of the vehicle.

FIG. 5 is a diagram illustrating an example of an operation of a vehicle performing a traveling route changing method to change a traveling route of the vehicle based on a movement of an emergency vehicle traveling from a rear-lateral side of the vehicle.

FIG. 6 is a diagram illustrating an example of an operation of a vehicle performing a traveling route changing method to change a traveling route of the vehicle based on a movement of an emergency vehicle traveling in a rear side of the vehicle when the vehicle travels on a single-lane road.

FIG. 7 is a diagram illustrating an example of a flow of operations performed by a traveling route changing apparatus included in a vehicle of a user.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. For example, as used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, components or one or more combinations/groups thereof in one or more example embodiments, but do not preclude the presence or addition of one or more other features, integers, operations, elements, components, and/or combinations/groups thereof in alternative embodiments, nor the lack of such stated features, integers, operations, elements, and/or components, and/or combinations/groups in further alternative embodiments unless the context and understanding of the present disclosure indicates otherwise. In addition, the use of the term ‘may’ herein with respect to an example or embodiment, e.g., as to what an example or embodiment may include or implement, means that at least one example or embodiment exists where such a feature is included or implemented while all examples and embodiments are not limited thereto.

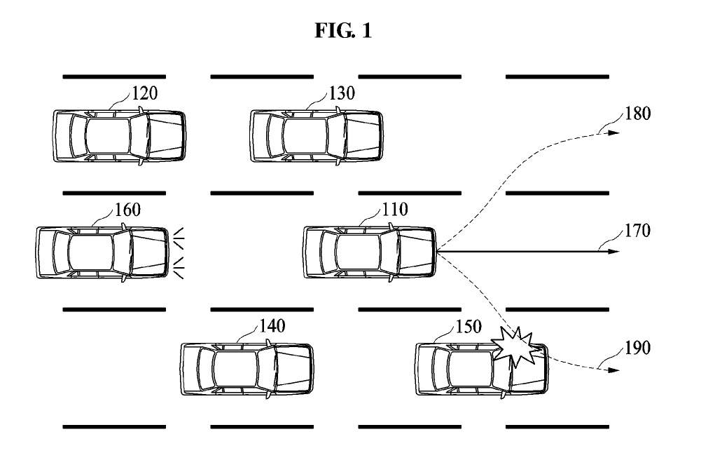

FIG. 1 is a diagram illustrating an example of how a vehicle 110 changes a traveling route 170 according to a traveling route changing method. Referring to FIG. 1, a plurality of vehicles 110, 120, 130, 140, 150, and 160 travels on a road divided into three lanes. Each of the vehicles 110, 120, 130, 140, 150, and 160 may include an advanced driver assistance system (ADAS).

In an example, vehicle described herein refers to any mode of transportation, delivery, or communication such as, for example, an automobile, a truck, a tractor, a scooter, a motorcycle, a cycle, an amphibious vehicle, a snowmobile, a boat, a public transit vehicle, a bus, a monorail, a train, a tram, an autonomous or automated driving vehicle, an intelligent vehicle, a self-driving vehicle, an aircraft, an unmanned aerial vehicle, a drone, or a mobile device. In an example, the position estimating apparatus is applicable to a robot requiring a positioning operation.

The traveling route changing method described herein may be performed by the ADAS. Hereinafter, it is assumed that the vehicle 110 includes an ADAS configured to perform the traveling route changing method. The ADAS configured to perform the traveling route changing method will be hereinafter referred to as a traveling route changing apparatus. As illustrated, the vehicle 110 is currently traveling along the traveling route 170. The ADAS of the vehicle 110 may control a steering system or a braking system of the vehicle 110 based on the traveling route 170. The ADAS of the vehicle 110 generates the route in a navigation system of a smart vehicle, generates location information to assist an autonomous or automated driving vehicle in steering, for in-vehicle driving assistance for fully autonomous or automated driving, and thus, enable safer and more comfortable driving.

In another example, the traveling route 170 may be output to a driver of the vehicle 110 through a display of the vehicle 110, and the driver may drive the vehicle 110 along the traveling route 170 displayed on the display of the vehicle 110.

The vehicle 110 performing the traveling route changing method may change the traveling route 170 based on a nearby vehicle. The nearby vehicle refers herein to a vehicle that is separate by a certain distance from a vehicle of a user or a vehicle present in an area that is set based on the vehicle, for example, the vehicle 110. The distance or the area may be determined based on a speed of the vehicle. In the example of FIG. 1, the vehicles 120, 130, 140, 150, and 160 are nearby vehicles located around the vehicle 110.

The vehicle 110 performing the traveling route changing method may change the traveling route 170 based on a nearby vehicle located in a rear side or in a rear-lateral side among the nearby vehicles 120, 130, 140, 150, and 160. The nearby vehicle located in the rear side refers to a vehicle traveling on a same lane as a lane on which the vehicle 110 travels, and is located opposite to a traveling direction of the vehicle 110, i.e., behind the vehicle 110. Referring to FIG. 1, the vehicle 160 is the nearby vehicle located in the rear side of the vehicle 110. The nearby vehicle located in the rear-lateral side refers to a vehicle traveling on another lane different from the lane on which the vehicle 110 travels, and is located opposite to the traveling direction of the vehicle 110. Referring to FIG. 1, the vehicles 120, 130, and 140 are the nearby vehicle located in the rear-lateral side of the vehicle 110.

The vehicle 110 performing the traveling route changing method may identify an emergency vehicle from the nearby vehicles located in the rear side or in the rear-lateral side of the vehicle 110. The emergency vehicle refers herein to a vehicle that urgently travels on a road, and seeks a concession from a vehicle traveling in front of the emergency vehicle or passes a vehicle traveling in front of the emergency vehicle. The emergency vehicle includes vehicles, such as, for example, an ambulance, a police car, a fire truck, and a tow truck. In an example, the vehicle 110 detects information such as, for example, a type of a nearby vehicle, a speed of the nearby vehicle, a state of the nearby vehicle, illumination on the nearby vehicle, sounds coming from the nearby vehicle using various sensors, and classify the nearby vehicle as the emergency vehicle based on the detected information. Referring to FIG. 1, the vehicle 160 located in the rear side of the vehicle 110 is the emergency vehicle that travels at a speed greater than or equal to a regulation speed with emergency lights on. The vehicle 110 detects an actuation state of the emergency lights of the vehicle 160 or the speed of the vehicle 160 using a sensor, and classifies the vehicle 160 as the emergency vehicle based on the detected actuation state or speed.

When the emergency vehicle is located in the rear side or in the rear-lateral side, the vehicle 110 may determine whether to change the traveling route 170 of the vehicle 110 not to obstruct or block traveling of the emergency vehicle. For example, when the vehicle 160 traveling at a speed of 130 kilometers per hour (km/h) approaches the vehicle 110 traveling at a speed of 100 km/h, the vehicle 110 may determine a change of the traveling route 170 to not obstruct the travel of the vehicle 160 that is classified as the emergency vehicle.

When it is determined that the traveling route 170 is to be changed, the vehicle 110 generates one or more candidate routes, for example, a candidate route 180 and a candidate route 190. The candidate routes 180 and 190 are virtual routes along which the vehicle 110 is to travel. In an example the candidate routes 180 and 190 are generated using a local map indicating a geographical distribution of nearby vehicles located around the vehicle 110. The vehicle 110 may generate a local map using factors such as, for example, at least one of a location of a nearby vehicle, for example, each of the nearby vehicles 120, 130, 140, 150, and 160 as illustrated in FIG. 1, a speed of the nearby vehicle, a lane along which the nearby vehicle travels, or a type of a road on which the vehicle 110 travels.

The local map may be used to compare the generated candidate routes 180 and 190 to change the traveling route 170. In an example, the vehicle 110 determines a risk involved with each of the candidate routes 180 and 190. For example, the vehicle 110 may calculate, for each of the candidate routes 180 and 190, a collision probability of the vehicle 110 colliding with a nearby vehicle in case the vehicle 110 travels along one of the candidate routes 180 and 190. In an example, the vehicle 110 select a candidate route having a lowest risk.

Referring to FIG. 1, when the vehicle 110 travels along the candidate route 190, the vehicle 110 may have a risk of colliding with the vehicle 150. When the vehicle 110 travels along the candidate route 180, the vehicle 110 may have a relatively low risk of colliding with the vehicle 130, compared to the risk of colliding with the vehicle 150 when travelling along the candidate route 190. This is because the vehicle 130 traveling on a lane through which the candidate route 180 passes is farther from the vehicle 110. Thus, the vehicle 110 may select the candidate route 180, and then travel along the selected candidate route 180. In an example, the ADAS of the vehicle 110 may control the steering system or the braking system of the vehicle 110 not based on the traveling route 170, but on the candidate route 180. In another example, the candidate route 180 may be output through the display of the vehicle 110 such that the driver of the vehicle 110 may drive the vehicle 110 along the candidate route 180. When the vehicle 110 travels along the candidate route 180, the vehicle 160 may smoothly travel without being stopped or decelerated by the vehicle 110.

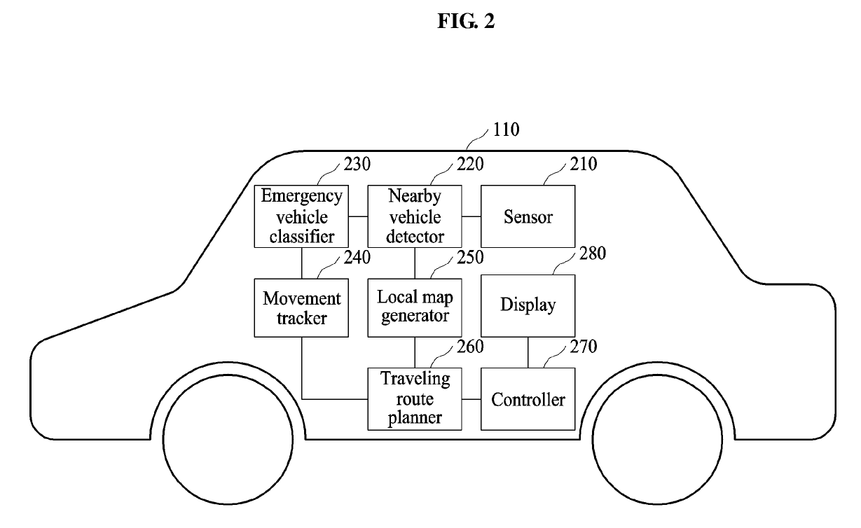

FIG. 2 is a diagram illustrating an example structure of the traveling route changing apparatus included in the vehicle 110. Referring to FIG. 2, the vehicle 110 includes at least one sensor 210 configured to generate an electrical signal based on an external environment of the vehicle 110. For example, the sensor 210 may be a global positioning system (GPS) sensor configured to detect a geographical location of the vehicle 110. The sensor 210 may also be a camera or an image sensor configured to capture an image or a video of an environment surrounding the vehicle 110 and generate the image or the video. The sensor 210 may also be a microphone or a sound sensor configured to collect sound around the vehicle 110. The sensor 210 may also be a light sensor to detect light, such as, for example, a photocell or photo resistor that changes its resistance when light shines on it. In addition, the sensor 210 may also be a radio detection and ranging (RADAR), a light detection and ranging (LiDAR or LADAR), or a sound navigation and ranging (SONAR), which may externally radiate a laser, a radio wave, or an ultrasonic wave, and collect a laser, a radio wave, or an ultrasonic wave reflected by an object located around the vehicle 110. In an example, the sensor 210 detects the object based on the reflected wave.

In an example, the traveling route changing apparatus includes the sensor 210, or is connected to the sensor 210 provided in the vehicle 110. Referring to FIG. 2, the traveling route changing apparatus includes a nearby vehicle detector 220 configured to detect a nearby vehicle from information associated with an environment surrounding the vehicle 110 that is collected by the sensor 210. The nearby vehicle detector 220 detects or identifies a nearby vehicle from various sets of information associated with the environment of the vehicle 110.

Traveling route changing apparatus also includes an emergency vehicle classifier 230 configured to classify an emergency vehicle from nearby vehicles located around the vehicle 110. The emergency vehicle classifier 230 may classify the emergency vehicle from the nearby vehicles based on various standards or conditions.

Various standards or conditions used to classify a nearby vehicle as an emergency vehicle by the emergency vehicle classifier 230 will be described in greater details below. The emergency vehicle classifier 230 may classify the nearby vehicle as the emergency vehicle based on an appearance of the nearby vehicle and a state of a device, a sound source, or a light source, for example, a siren, emergency lights, and high beams. In an example, the emergency vehicle classifier 230 may classify the nearby vehicle as the emergency vehicle using a signal generated by the nearby vehicle through, for example, vehicle-to-vehicle (V2V) communication.

For example, when a type of a nearby vehicle corresponds to a type of an emergency vehicle, for example, an ambulance, a police car, and a fire truck, the emergency vehicle classifier 230 may classify the nearby vehicle as the emergency vehicle. When a nearby vehicle includes a siren, the emergency vehicle classifier 230 may classify the nearby vehicle as an emergency vehicle. When emergency lights of a nearby vehicle blink regularly, or the emergency lights are activated, the emergency vehicle classifier 230 may classify the nearby vehicle as the emergency vehicle. When high beams of a nearby vehicle are on or blink regularly, the emergency vehicle classifier 230 may classify the nearby vehicle as the emergency vehicle. When a horn of a nearby vehicle is sounded or the horn is sounded repeatedly, the emergency vehicle classifier 230 may classify the nearby vehicle as the emergency vehicle. When an identifier indicating an emergency vehicle, for example, a “119” mark, a “911” mark, an “ECNALUBMA” mark, and an “AMBULANCE” mark, is indicated on a nearby vehicle, the emergency vehicle classifier 230 may classify the nearby vehicle as the emergency vehicle.

In addition, the emergency vehicle classifier 230 may classify a nearby vehicle as the emergency vehicle based on a movement of the nearby vehicle including, for example, a speed, an accelerated speed, a relative speed, and a direction of the nearby vehicle. For example, when a nearby vehicle travels at a speed greater than or equal to a speed limit of a road, the emergency vehicle classifier 230 may classify the nearby vehicle as the emergency vehicle. When a nearby vehicle passes repeatedly or attempts to pass, the vehicle 110, the emergency vehicle classifier 230 may classify the nearby vehicle as the emergency vehicle. When a nearby vehicle approaches the vehicle 110 from a rear side of the vehicle 110 without reducing a speed, although a distance between the nearby vehicle and the vehicle 110 is less than or equal to a preset distance, for example, a safety distance, the emergency vehicle classifier 230 may classify the nearby vehicle as the emergency vehicle.

In addition, the emergency vehicle classifier 230 may classify a nearby vehicle as the emergency vehicle based on a state of a road on which the nearby vehicle travels. For example, when a nearby vehicle travels on an emergency lane or a shoulder, or the nearby vehicle attempts to enter the emergency lane, the emergency vehicle classifier 230 may classify the nearby vehicle as the emergency vehicle. When a nearby vehicle travels on a lane on which a type of the nearby vehicle is not allowed to travel, for example, the nearby vehicle travels on a bus-only lane despite the nearby vehicle being a passenger car, the emergency vehicle classifier 230 may classify the nearby vehicle as the emergency vehicle.

The emergency vehicle classifier 230 may classify a nearby vehicle as the emergency vehicle based on a combination of the standards or conditions described above. For example, the emergency vehicle classifier 230 may classify, as the emergency vehicle, a nearby vehicle approaching the vehicle 110 with emergency lights on at a distance less than or equal to a preset distance or at a speed greater than or equal to a preset threshold speed. In another example, the emergency vehicle classifier 230 may classify, as the emergency vehicle, a nearby vehicle traveling at a preset speed or higher with emergency lights on.

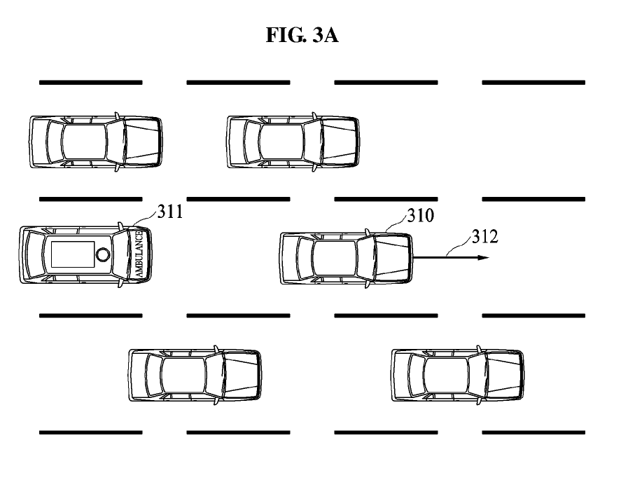

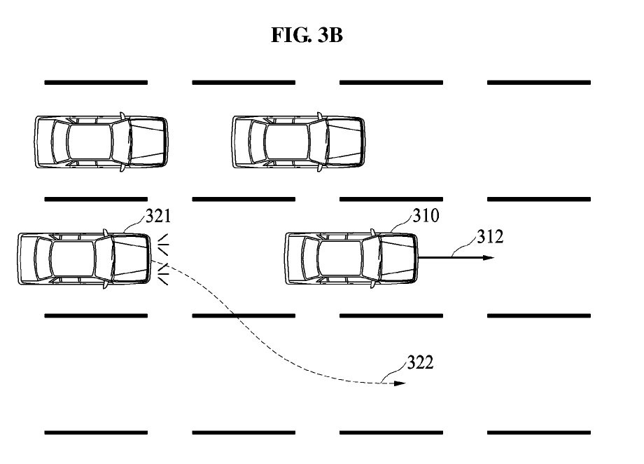

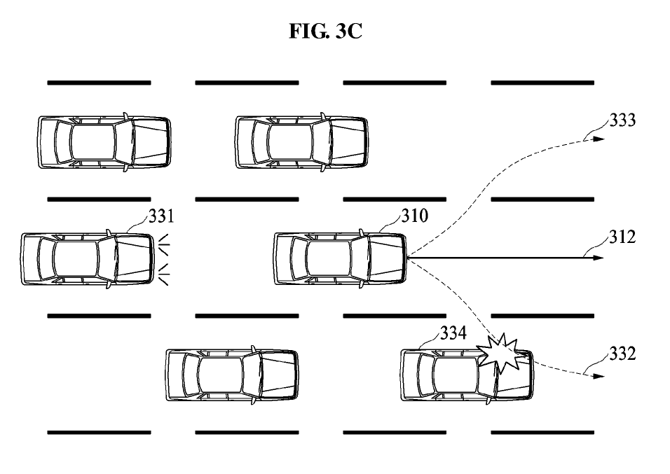

Referring to FIG. 2, the traveling route changing apparatus includes a movement tracker 240 configured to track a movement of a nearby vehicle that is classified as the emergency vehicle. In an example, the tracked movement of the emergency vehicle is used to determine an intention of a driver of the emergency vehicle. In an example, the movement tracker 240 determines whether to change or maintain a traveling route of the vehicle 110 based on the movement of the emergency vehicle. For example, when the driver of the emergency vehicle attempts to pass the vehicle 110 from a rear side of the vehicle 110, the movement tracker 240 may maintain the traveling route or a lane to not obstruct the movement of the emergency vehicle. When the driver of the emergency vehicle requests the vehicle 110 to make way for the emergency vehicle from the rear side of the vehicle 110 using, for example, a siren, emergency lights, high beams, a loudspeaker, and a speaker, the movement tracker 240 may operate such that the vehicle 110 changes the traveling route or the lane. An operation of the movement tracker 240 to determine whether to change or maintain the traveling route of the vehicle 110 will be described in greater detail with reference to FIGS. 3A through 3C.

Referring to FIG. 2, the traveling route changing apparatus includes a traveling route planner 260 configured to change or plan the traveling route of the vehicle 110 based on the movement of the emergency vehicle. In an example, when the movement tracker 240 determines a change of the traveling route of the vehicle 110, the movement tracker 240 requests the traveling route planner 260 to change the traveling route. The traveling route planner 260 may generate a plurality of candidate routes, and then evaluate a risk involved with each of the candidate routes. The traveling route planner 260 selects one of the candidate routes based on the evaluated risk involved with each of the candidate routes.

Referring to FIG. 2, the traveling route changing apparatus includes a local map generator 250 configured to generate a local map indicating a geographical distribution of nearby vehicles located around the vehicle 110. The local map may be generated based on the vehicle 110, and include information associated with a nearby vehicle present near the vehicle 110, or present in an area or a radius that is determined based on a speed of the vehicle 110. In an example, a size of the area or the radius in the local map is proportional to the speed of the vehicle 110. The local map generator 250 may transmit the generated local map to the traveling route planner 260. The traveling route planner 260 may use the local map to generate the candidate routes or evaluate the risk involved with each of the candidate routes.

Referring to FIG. 2, the traveling route changing apparatus includes a controller 270 configured to control a movement of the vehicle 110. When the traveling route planner 260 transmits information associated with the selected candidate route to the controller 270, the controller 270 may control a steering system or a braking system of the vehicle 110 based on the selected candidate route. Thus, the vehicle 110 may then travel along the selected candidate route in lieu of the traveling route. In another example, the controller 270 may output the selected candidate route for the driver of the vehicle 110.

In an example, the controller 270 may output the selected candidate route to a display 280. In an example, the traveling route changing apparatus displays the selected candidate route on a windshield glass of the vehicle through a head-up display (HUD). However, the displaying of the position is not limited to the example described in the forgoing, and any other instrument cluster, vehicular infotainment system, screen in the vehicle that uses augmented reality, or display panel in the vehicle may perform the display function. Other displays, such as, for example, smart phone and eye glass display (EGD) that are operatively connected to the controller 270 may be used without departing from the spirit and scope of the illustrative examples described. In another example, the traveling route changing apparatus outputs the selected candidate route using an audio signal through a speaker.

The structure of the traveling route changing apparatus is conceptually illustrated in FIG. 2, and at least one of the nearby vehicle detector 220, the emergency vehicle classifier 230, the movement tracker 240, the local map generator 250, or the traveling route planner 260, controller, 270 may be embodied as a single-core processor or a multi-core processor. Further details on these components are provided below.

In an example, the vehicle 110 is an automatic or autonomous vehicle, and FIG. 2 illustrates an example of the traveling route changing apparatus operating as a path planner that may intervene in an operation of changing or generating a traveling route of the automatic vehicle. The traveling route changing apparatus may be embodied as various forms, in addition to being included in the ADAS included in the vehicle 110.

In another example, the traveling route changing apparatus may be embodied in various portable devices, such as, for example, a smartphone, a smart tablet, a laptop, a global positioning system (GPS) navigation, a personal navigation device, portable navigation device (PND), a handheld game console, and a personal digital assistant (PDA). In such an example, the traveling route changing apparatus is a component of the portable device, for example, navigation applications and smart car applications. The portable device performing the traveling route changing method may be connected to the sensor 210 or the controller 270 provided in the vehicle 110 through a wireless or wired network. When the portable device is connected to the sensor 210, the portable device may output a candidate route through a display 280 provided in the vehicle 110 or the portable device, and thus a user of the vehicle 110 may drive the vehicle 110 along the output candidate route.

FIGS. 3A through 3C are diagrams illustrating examples of an operation of a vehicle 310 performing a traveling route changing method to determine whether to change a traveling route 312 of the vehicle 310. Hereinafter, various examples of how the vehicle 310 determines whether to change the traveling route 312 will be described. In the examples, the vehicle 310 is set to currently travel along the traveling route 312.

Referring to FIG. 3A, an emergency vehicle 311 is located behind the vehicle 310 or in a rear side of the vehicle 310. An identifier indicating the emergency vehicle 311 is attached to a surface of the emergency vehicle 311. The vehicle 310 uses a sensor to detect the identifier attached to the surface of the emergency vehicle 311, and identifies the emergency vehicle 311 based on the detected identifier.

The vehicle 310 tracks a movement of the emergency vehicle 311, and determines whether to change the traveling route 312. Although the emergency vehicle 311 is located in the rear side of the vehicle 310, the vehicle 310 may not need to change the traveling route 312. For example, when a relative speed of the emergency vehicle 311 is not that high relative to the vehicle 310, the emergency vehicle 311 does not approach the vehicle 310, and the vehicle 310 may not change the traveling route 312 although the emergency vehicle 311 is located in the rear side of the vehicle 310. In another example, when a distance between the emergency vehicle 311 and the vehicle 310 does not decrease, the vehicle 310 may not change the traveling route 312 although the emergency vehicle 311 is located in the rear side of the vehicle 310.

The vehicle 310 determines whether to change the traveling route 312 based on a state of the emergency vehicle 311 in addition to a physical movement of the emergency vehicle 311. For example, when the emergency vehicle 311 does not sound a siren although the emergency vehicle 311 includes the siren, the vehicle 310 may not change the traveling route 312.

Referring to FIG. 3B, an emergency vehicle 321 is located behind the vehicle 310 or in a rear side of the vehicle 310. Although the emergency vehicle 321 does not include a mark, the vehicle 310 identifies the emergency vehicle 321 based on whether emergency lights, high beams, or a horn of the emergency vehicle 321 are actuated. In the example of FIG. 3B, the emergency vehicle 321 travels with the emergency lights on or the high beams on, and is to travel along a traveling route 322. That is, the emergency vehicle 321 changes a lane on which the emergency vehicle 321 is currently traveling to pass the vehicle 310.

The vehicle 310 notices that the emergency vehicle 321 is to travel along the traveling route 322 by tracking a movement of the emergency vehicle 321. The vehicle 310 determines that a driver of the emergency vehicle 321 is attempting to pass the vehicle 310. Thus, the vehicle 310 does not change the traveling route 312, and continues traveling along the traveling route 312. Thus, the driver of the emergency vehicle 321 passes the vehicle 310 without being obstructed by the vehicle 310.

Referring to FIG. 3C, an emergency vehicle 331 is located behind the vehicle 310 or in a rear side of the vehicle 310. In the example of FIG. 3C, the emergency vehicle 331 approaches the vehicle 310 without changing a lane. That is, a relative speed of the emergency vehicle 331 is high relative to a speed of the vehicle 310, or a distance between the emergency vehicle 331 and the vehicle 310 decreases. In such a case, the vehicle 310 determines that a driver of the emergency vehicle 331 seeks a concession from the vehicle 310. Thus, the vehicle 310 changes the traveling route 310 to help the emergency vehicle 331 travel rapidly.

Referring to FIG. 3C, to change the traveling route 312, the vehicle 310 compares candidate routes 332 and 333. The vehicle 310 calculates a collision probability of the vehicle 310 colliding in case the vehicle 310 travels along each of the candidate routes 332 and 333. A collision probability calculated when the vehicle 310 travels along the candidate route 332 is greater than a collision probability calculated when the vehicle 310 travels along the candidate route 333 because a nearby vehicle 334 is present on the candidate route 332. The vehicle 310 determines that the collision probability for the candidate route 332 is greater than the collision probability for the candidate route 333 using a local map. Thus, the vehicle 310 selects the candidate route 333 along which the vehicle 310 is to travel.

As described above, the vehicle 310 determines whether to change the travel route 312 based on the movements or states of the extracted emergency vehicles 311 of FIG. 3A, 321 of FIG. 3B, and 331 of FIG. 3C, respectively. When it is determined that there is an intention of inducing the vehicle 310 to yield based on the movements or states of the emergency vehicles 311, 321, and 331, the vehicle 310 may change the traveling route 312. Thus, the emergency vehicles 311, 321, and 331 may arrive at a destination more quickly and safely without being obstructed by the vehicle 310.

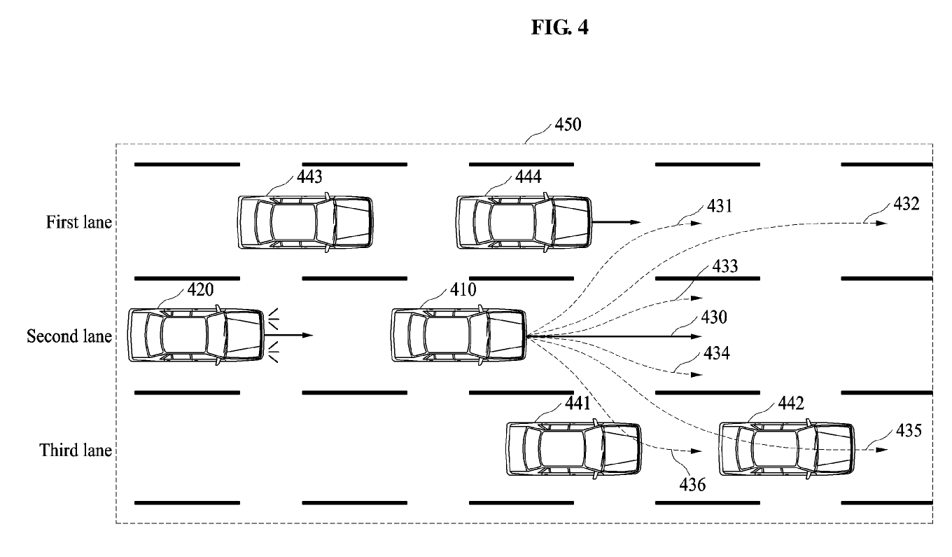

FIG. 4 is a diagram illustrating an example of an operation of a vehicle 410 performing a traveling route changing method to change a traveling route 430 of the vehicle 410. The vehicle 410 notices a presence of an emergency vehicle 420 located behind, or in a rear side of, the vehicle 410 while traveling along the traveling route 430, and determines a change of the traveling route 430 based on a movement of the emergency vehicle 420.

The vehicle 410 generates a local map including information associated with at least one of respective locations, types, states, and speeds of nearby vehicles 441, 442, 443, and 444, and the emergency vehicle 420. In the local map, information associated with a speed may be indicated as a vector that simultaneously represents a direction and a speed. Referring to FIG. 4, the vehicle 410 generates the local map targeting a vehicle present in an area 450. The area 450 refers to a geographical space that is set based on the vehicle 410, and a size of the area 450 may be determined based on a form of a road on which the vehicle 410 travels, for example, a curvature and a width of the road, or a speed of the vehicle 410. When the size of the area 450 is determined based on the speed of the vehicle 410, the size of the area 450, or a size of the local map, may increase when the vehicle 410 travels faster.

When the vehicle 410 determines the change of the traveling route 430 is needed, the vehicle 410 generates a plurality of candidate routes using the local map. As illustrated in FIG. 4, candidate route 1 “431,” candidate route 2 “432,” candidate route 3 “433,” candidate route 4 “434,” candidate route 5 “435,” and candidate route 6 “436” are generated. A candidate route may require the vehicle 410 to change one or more lanes, or to move a location of the vehicle 410 within a lane without changing the lane. Referring to FIG. 4, the candidate route 1 “431,” the candidate route 2 “432,” the candidate route 5 “435,” and the candidate route 6 “436” require the vehicle 410 to change the lane by one or more lanes. Referring to FIG. 4, the candidate route 3 “433” and the candidate route 4 “434” require the vehicle 410 to change the location of the vehicle 410 without changing the lane of the vehicle 410. When the vehicle 410 travels on a road including at least three lanes, the number of candidate routes may increase in proportion to the number of the lanes on the road.

The vehicle 410 evaluates the generated candidate routes using the local map. The vehicle 410 evaluates a risk involved with each of the candidate routes 1 through 6 431 through 436 based on the movements of the nearby vehicles 441, 442, 443, and 444 in the area 450.

The risk involved with each of the candidate routes 1 through 6 431 through 436 is determined based on a collision probability for each of the candidate routes 1 through 6 431 through 436 in case the vehicle 410 travels along one of the candidate routes 1 through 6 431 through 436. When the vehicle 410 travels along a candidate route k, a collision probability of the vehicle 410 colliding is R(k). The collision probability R(k) is determined based on factors such as, for example, a shortest distance between a nearby vehicle located on a lane through which the candidate route k passes, a time to collision (TTC), or a speed of the nearby vehicle traveling on the lane, for example, the nearby vehicle located behind the vehicle 410 on the candidate route k. Referring to FIG. 4, the vehicle 410 selects a candidate route having a lowest collision probability R(k) to be a new traveling route. Hereinafter, how the vehicle 410 calculates a collision probability for each of the candidate routes 1 through 6 431 through 436 based on the traveling route changing method and compares the calculated collision probabilities will be described in greater detail below.

Although there are a plurality of candidate routes entering a same lane, collision probabilities for all candidate routes may differ because forms of the candidate routes are different from one other. Referring to FIG. 4, when the vehicle 410 travels along any one of the candidate route 1 “431” and the candidate route 2 “432,” the vehicle 410 enters the first lane. However, since forms of the candidate route 1 “431” and the candidate route 2 “432” are different from each other, a collision probability R(1) corresponding to the candidate route 1 “431” and a collision probability R(2) corresponding to the candidate route 2 “432” differ from each other. In addition, a distance between the vehicle 410 and the nearby vehicle 444 when the vehicle 410 enters the first lane along the candidate route 1 “431” is shorter than a distance between the vehicle 410 and the nearby vehicle 444 when the vehicle 410 enters the first lane along the candidate route 2 “432.” Thus, the collision probability R(1) is determined to be relatively greater than the collision probability R(2).

When the vehicle 410 travels along the candidate route 6 “436,” a distance between the vehicle 410 and the nearby vehicle 441 is 0, and thus, it is likely that the vehicle 410 collides with the nearby vehicle 441, if the vehicle 410 travel along candidate route 6 “436.” Similarly, when the vehicle 410 travels along the candidate route 5 “435,” the candidate route 5 435 and the nearby vehicle 442 overlap with each other, and thus, it is likely that the vehicle 410 collides with the nearby vehicle 442, if the vehicle 410 travel along candidate route 6 “436.” Thus, a collision probability R(5) of the vehicle 410 colliding if the vehicle 410 travels along the candidate route 5 “435” and a collision probability R(6) of the vehicle 410 colliding if the vehicle 410 travels the candidate route 6 “436” are determined to be relatively greater than the collision probabilities R(1) through R(4).

The emergency vehicle 420 is also included in the local map, and thus, the vehicle 410 uses a movement of the emergency vehicle 420 to evaluate the candidate routes 1 through 6 431 through 436. Referring to FIG. 4, when the vehicle 410 travels along the candidate route 3 “433” or the candidate route 4 “434,” it is possible that the vehicle 410 collides with the emergency vehicle 420 or the vehicle 410 obstructs or blocks the movement of the emergency vehicle 420. Thus, the collision probability R(3) of the vehicle 410 colliding in case the vehicle 410 travels along the candidate route 3 “433” and the collision probability R(4) of the vehicle 410 colliding in case the vehicle 410 travels along the candidate route 4 “434” are determined to be relatively greater values.

Thus, a candidate route having a lowest collision probability of the vehicle 410 colliding with the nearby vehicle 441, 442, 443, or 444, while allowing the vehicle 410 not to obstruct the movement of the emergency vehicle 420, is determined to be the candidate route 2 “432.” Thus, the vehicle 410 selects the candidate route 2 “432” to be the new traveling route in lieu of the traveling route 430. That is, the vehicle 410 travels along the candidate route 2 432, without continuing traveling along the traveling route 430.

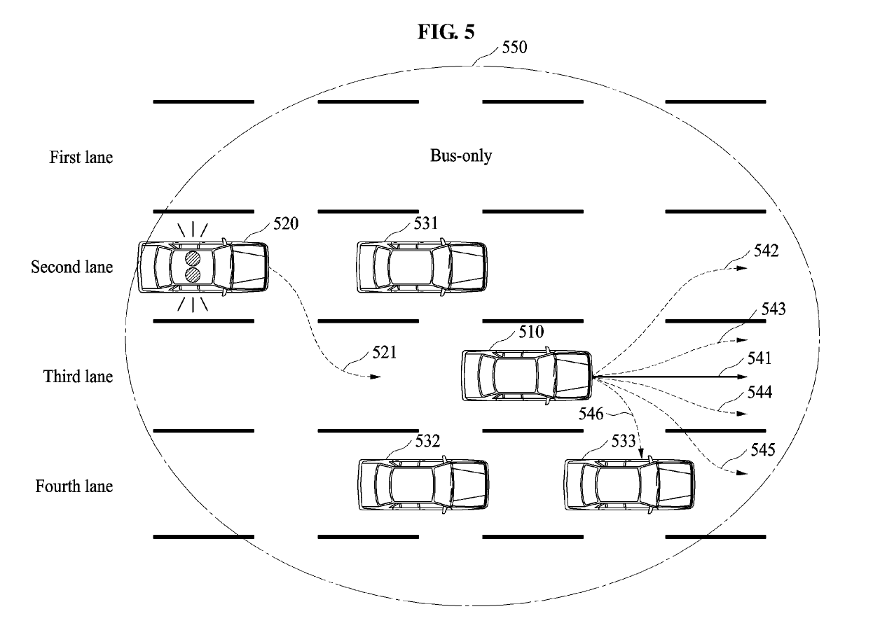

As described above, FIG. 4 discloses how the vehicle 410 performs the traveling route changing method when the emergency vehicle 420 travels behind the vehicle 410 on a same lane as the vehicle 410. FIG. 5 is a diagram illustrating an example of an operation of a vehicle 510 performing a traveling route changing method to change a traveling route 541 of the vehicle 510 based on a movement of an emergency vehicle 520 traveling from a rear-lateral side of the vehicle 510. In the example of FIG. 5, it is assumed that the vehicle 510 is a passenger car that travels on a third lane of a road along the current traveling route 541. Referring to FIG. 5, the vehicle 510 identifies nearby vehicles 531, 532, and 533, and the emergency vehicle 520 by detecting an environment of an area 550 that is set based on the vehicle 510. The vehicle 510 generates a local map indicating a distribution of the nearby vehicles 531, 532, and 533, and the emergency vehicle 520 that are identified within the area 550. A size of the area 550 may be proportional to a speed of the vehicle 510. A form of the area 550 may be changed based on the environment. Other forms of the area 550, such as, for example, the area 450 of a quadrangular form as illustrated in FIG. 4, in addition to the area 550 of a circular form as illustrated in FIG. 5, are considered to be well within the scope of the present disclosure.

In the example of FIG. 5, it is assumed that the emergency vehicle 520 enters, along a traveling route 521, a lane on which the vehicle 510 is currently located. The vehicle 510 identifies a movement of the emergency vehicle 520, for example, the traveling route 521. The vehicle 520 determines whether to change the traveling route 541 based on the identified traveling route 521 of the emergency vehicle 520. When the emergency vehicle 520 comes closer to the vehicle 510 by a distance less than or equal to a preset distance by traveling along the traveling route 521, the vehicle 510 may determine to change the traveling route 541.

The vehicle 510 generates a plurality of candidate routes 542, 543, 544, 545, and 546 using the generated local map. The vehicle 510 evaluates a risk involved with each of the generated candidate routes 542, 543, 544, 545, and 546 using the local map. An operation of evaluating the risk involved with each of the candidate routes 542, 543, 544, 545, and 546 may be performed similarly as described with reference to FIG. 4. In addition to the description of FIG. 5 below, the descriptions of evaluating the risk involved with each of the candidate routes of FIG. 4 are incorporated herein by reference. Thus, the above description may not be repeated here. Referring to FIG. 5, a risk evaluated when the vehicle 510 enters a second lane along the candidate route 542 is less than a risk evaluated when the vehicle 510 enters a fourth lane along any one of the candidate routes 545 and 546. Thus, the vehicle 510 selects the candidate route 542 to be a new traveling route in lieu of the traveling route 541.

The selection of one candidate route from a plurality of candidate routes based on a risk involved with each of the candidate routes, i.e., a collision probability for each of the candidate routes, has been described with reference to FIGS. 4 and 5. Further, the vehicle 510 may select one from the candidate routes based on a state of a road on which the vehicle 510 travels, a state of a destination of the vehicle 510, or a lane to which the vehicle 510 enters along a candidate route, in addition to the collision probability.

For example, the vehicle 510 may detect a road condition of each of lanes on the road, and use the detected road condition to select one of the candidate routes. When there is a controlled or restricted lane, the vehicle 510 may select, from the candidate routes, a candidate route that does not pass through the controlled or restricted lane. Referring to FIG. 5, the vehicle 510 does not generate or select a candidate route that passes through a first lane, which is a bus-only lane. In another example, the vehicle 510 may not select a lane that leads away from a destination of the vehicle 510, for example, the lane leads to a highway exit or a right turn-only lane. The vehicle 510 may select one from the candidate routes based on a traffic volume of the road or a traffic congestion of each lane.

As described, information associated with the road condition, the restricted lane, and the traffic volume of each lane may be applied to an operation of generating the candidate routes. For example, in a case in which the local map includes information associated with at least one of the road condition, the restricted lane, or the traffic volume of each lane, the vehicle 510 may generate the candidate routes based on the information associated with the at least one of the road condition, the restricted lane, or the traffic volume of each lane.

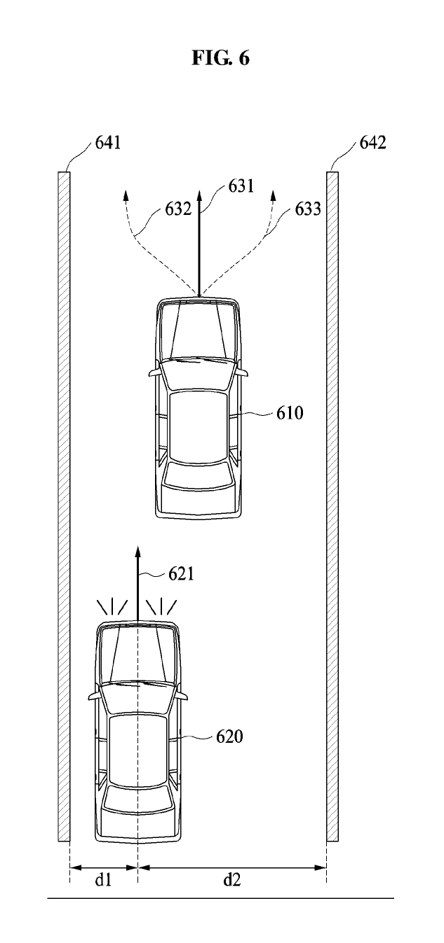

FIG. 6 is a diagram illustrating an example of an operation of a vehicle 610 performing a traveling route changing method to change a traveling route 631 of the vehicle 610 based on a movement of an emergency vehicle 620 behind the vehicle 610 when the vehicle 610 travels on a single-lane road. In the example of FIG. 6, it is assumed that the single-lane road includes a single lane with a boundary of a left-hand side line 641 and a right-hand side line 642, and the emergency vehicle 620 approaches the vehicle 610 along a traveling route 621 with emergency lights on.

As described above, in an example, the vehicle 610 identifies the emergency vehicle 620 based on actuation of the emergency lights of the emergency vehicle 620 or whether the emergency vehicle 620 approaches the vehicle 610. The vehicle 610 tracks a movement of the emergency vehicle 620 for a preset period of time, and determines the traveling route 621 of the emergency vehicle 620. The vehicle 610 determines a change of the traveling route 631 is needed so as not to obstruct the movement of the emergency vehicle 620.

Referring to FIG. 6, the vehicle 610 generates a plurality of candidate routes 632 and 633. Since the vehicle 610 travels on the single-lane road, the vehicle 610 generates the candidate routes 632 and 633 that are close to the left-hand side line 641 and the right-hand side line 642, respectively, without changing the lane. Since a distance d1 between the emergency vehicle 620 and the left-hand side line 641 is shorter than a distance d2 between the emergency vehicle 620 and the right-hand side line 642, the vehicle 610 selects the candidate route 633 close to the right-hand side line 642, in order not to obstruct the traveling route 621 of the emergency vehicle 620. Thus, the vehicle 610 gets closer to the right-hand side line 640, instead of traveling at a center of the lane along the traveling route 631.

Although not illustrated, when there is a nearby vehicle preceding the vehicle 610, the vehicle 610 may select a candidate route based on a movement of the nearby vehicle. For example, when the nearby vehicle preceding the vehicle 610 travels adjacent to the right-hand side line 642, the vehicle 610 may select the candidate route 633 along which the vehicle 610 approaches the right-hand side line 642 following the nearby vehicle. In another example, when the nearby vehicle preceding the vehicle 610 stops in a space adjacent to the right-hand side line 642, the vehicle 610 may stop behind the nearby vehicle. Thus, the emergency vehicle 620 may travel on the road rapidly without colliding with the vehicle 610 and also the nearby vehicle preceding the vehicle 610.

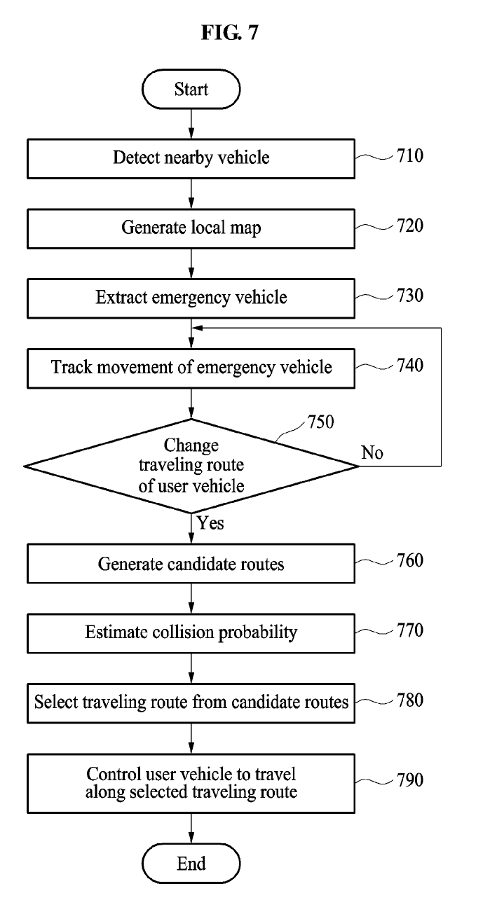

FIG. 7 is a diagram illustrating an example of a flow of operations performed by a traveling route changing apparatus included in a vehicle of a user. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. One or more blocks of FIG. 7, and combinations of the blocks, can be implemented by special purpose hardware-based computer that perform the specified functions, or combinations of special purpose hardware and computer instructions. In addition to the description of FIG. 7 below, the descriptions of FIGS. 1-6 are also applicable to FIG. 7, and are incorporated herein by reference. Thus, the above description may not be repeated here.

A non-transitory computer-readable medium may be provided to a computer in which a program used to implement a traveling route changing method performed by the traveling route changing apparatus described herein is recorded. The program may include at least one of an application program, a device driver, a firmware, a middleware, a dynamic-link library (DLL), or an applet, which store the traveling route changing method. An ADAS or the traveling route changing apparatus that is included in the vehicle of the user may include a processor, and the processor may perform the traveling route changing method by reading the computer-readable medium in which the traveling route changing method is recorded. Additional details of the non-transitory computer-readable medium and the processor is provided below.

Referring to FIG. 7, in operation 710, the traveling route changing apparatus detects at least one nearby vehicle located around a vehicle of a user, hereinafter referred to as a user vehicle. In an example, the user vehicle may includes various types of sensors to detect the nearby vehicle. In an example, an area in which the traveling route changing apparatus detects the nearby vehicle is determined based on a speed of the user vehicle. The traveling route changing apparatus may identify at least one of a location, a type, an appearance, a state, a speed, a traveling direction, or a traveling lane of the nearby vehicle.

Further, the traveling route changing apparatus may collect information associated with a road on which the user vehicle travels. The information may include information such as, for example, at least one of a road condition, a restricted speed for the road, the number of lanes on the road, a restricted speed on each of the lanes, a restricted type of a vehicle for each of the lanes, whether each of the lanes is controlled or restricted, whether each of the lanes is congested or not, or whether each of the lane leads away from a desired destination of the user vehicle.

In operation 720, the traveling route changing apparatus generates a local map indicating a distribution of the detected nearby vehicle based on the user vehicle. The user vehicle may be located at a center of the local map, and a size of the local map may be determined based on a size of the area in which the nearby vehicle is detected by the traveling route changing apparatus, or on a speed of the user vehicle. The local map may include the information associated with the road, in addition to the location, the speed, and the direction of the nearby vehicle. In an example, the local map includes one or more than one nearby vehicle.

In operation 730, the traveling route changing apparatus extracts an emergency vehicle from among the nearby vehicle. The traveling route changing apparatus may extract the emergency vehicle based on factors such as, for example, the location, the appearance, the type, the state, the speed, and the traveling direction of the nearby vehicle.

In operation 740, the traveling route changing apparatus tracks a movement of the emergency vehicle. The tracking may be performed on the extracted emergency vehicle. The traveling route changing apparatus may accumulate movements per hour of the emergency vehicle, and determine a traveling route along which the emergency vehicle is expected to travel.

In operation 750, the traveling route changing apparatus determines whether to change a traveling route of the user vehicle. The traveling route changing apparatus may determine whether the emergency vehicle changes a lane, or calculate a change in a distance between the emergency vehicle and the user vehicle, based on tracking the movement of the emergency vehicle. Based on whether the emergency vehicle changes the lane, or the calculated change in the distance between the emergency vehicle and the user vehicle, the traveling route changing apparatus may determine whether to change the traveling route of the user vehicle.

In operation 760, when it is determined that the traveling route is to be changed, in an example, the traveling route changing apparatus generates a plurality of candidate routes along which the user vehicle is to travel based on a movement of the at least one nearby vehicle and the movement of the emergency vehicle. The local map generated in operation 720 may be used to generate the candidate routes. In an example, the traveling route changing apparatus generates a candidate route that requires the user vehicle to change a lane. In another example, the traveling route changing apparatus generates a candidate route that allows the user vehicle to approach a line of the lane, for example, a left-hand side line and a right-hand side line that separate lanes, without the user vehicle changing the lane.

In an example, operation 720 of generating the local map is performed prior to operation 760. In another example, operation 720 of generating the local map is performed after operation 740 or 750 is performed, after operation 730 is performed.

In operation 770, the traveling route changing apparatus estimates a collision probability for each of the candidate routes, or a collision probability of the user vehicle colliding with the nearby vehicle if the user vehicle travels along one of the candidate routes. In an example, the traveling route changing apparatus estimates the collision probability using the local map. When there is a candidate route that requires the user vehicle to change the lane on which the user vehicle is currently traveling, the traveling route changing apparatus may estimate a collision probability based on a relationship between a nearby vehicle traveling on the changed lane and the candidate route. For example, the traveling route changing apparatus estimates the collision probability for the candidate route based on a distance between the nearby vehicle and the user vehicle along the candidate route, or a time to collision (TTC).

In operation 780, the traveling route changing apparatus selects, a candidate route from the candidate routes, to be a new traveling route of the user vehicle based on the collision probability estimated for each of the candidate routes. The traveling route changing apparatus may select a candidate route having a lowest collision probability, to be the new traveling route. Further, the traveling route changing apparatus may select a candidate route that allows the user vehicle to travel smoothly without obstructing the movement of the emergency vehicle based further on the information associated with the road.

In operation 790, the traveling route changing apparatus controls the user vehicle to travel along the selected traveling route. In an example, the traveling route changing apparatus is connected to a steering system or a control system of the user vehicle. The traveling route changing apparatus controls the user vehicle by transmitting a control signal to the steering system or the control system. Thus, the user vehicle may make way for the emergency vehicle without obstructing or blocking the emergency vehicle such that the emergency vehicle travels rapidly.

As described, the traveling route changing apparatus included in the user vehicle determines whether an emergency vehicle is present among nearby vehicles. When the emergency vehicle is present, the traveling route changing apparatus may track a movement of the emergency vehicle. The traveling route changing apparatus may determine whether to change a traveling route of the user vehicle such that the emergency vehicle may travel without being obstructed by the user vehicle. When it is determined to change the traveling route of the user vehicle, the traveling route changing apparatus generates a plurality of candidate routes. The traveling route changing apparatus may evaluate a risk involved with each of the candidate routes, and select a candidate route with a lowest risk to be a new traveling route of the user vehicle. The traveling route changing apparatus may control the user vehicle to travel along the selected candidate route based on the selected candidate route. Thus, the emergency vehicle may travel smoothly without being obstructed by the user vehicle.

The traveling route changing apparatus, nearby vehicle detector 220, vehicle classifier 230, movement tracker 240, local map generator 250, traveling route planner 260, controller 270, and other apparatuses, units, modules, devices, and components illustrated in FIG. 2 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The method illustrated in FIG. 7 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software includes at least one of an applet, a dynamic link library (DLL), middleware, firmware, a device driver, an application program storing the method of preventing the collision. In another example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A traveling route changing method, comprising:
detecting at least one nearby vehicle located around a vehicle;
extracting an emergency vehicle among the at least one nearby vehicle;
tracking a movement of the emergency vehicle; and
determining whether to change a traveling route of the vehicle, in response to the movement of the emergency vehicle.

2. The method of claim 1, wherein the extracting of the emergency vehicle comprises:
extracting the emergency vehicle based on any one or any combination of a type of the at least one nearby vehicle, a state of the nearby vehicle, illumination on the nearby vehicle, whether a siren of the at least one nearby vehicle is activated, relative speeds of the at least one nearby vehicle and the vehicle, whether a horn of the at least one nearby vehicle is activated, an identifier on the at least one nearby vehicle, and a signal generated by the nearby vehicle.

3. The method of claim 1, wherein the determining of whether to change the traveling route comprises:
determining whether to change the traveling route based on
whether the emergency vehicle changes to another lane or on a change in a distance between the emergency vehicle and the vehicle due to the movement of the emergency vehicle.

4. The method of claim 1, further comprising:
generating candidate routes for the vehicle to travel based on a movement of the at least one nearby vehicle, in response to a determination to change the traveling route;
estimating, for each of the candidate routes, a collision probability of the vehicle colliding with the at least one nearby vehicle; and
selecting, to be a new traveling route of the vehicle, a candidate route having a lowest collision probability, from among the candidate routes.

5. The method of claim 4, wherein the candidate routes comprises a candidate route allowing the vehicle to move towards a border line of a lane on which the vehicle is travelling without changing to another lane.

6. The method of claim 4, wherein, in response to a candidate route where the vehicle changes to another lane being among the candidate routes, the estimating of the collision probability comprises:
estimating the collision probability based on a nearby vehicle traveling on the another lane.

7. The method of claim 4, further comprising:
controlling the vehicle to travel along the selected traveling route.

8. The method of claim 1, further comprising:
generating a local map indicating a location of each of the at least one nearby vehicle and the vehicle, and a size of the local map is determined based on a speed of the vehicle.

9. The method of claim 8, wherein the local map is generated based on any one or any combination of the location of the at least one nearby vehicle, a speed of the at least one nearby vehicle, a speed of the vehicle, a lane along which the at least one nearby vehicle travels, or a type of a road on which the at least one nearby vehicle travels, a lane of the vehicle, a type of a road on which the vehicle travels, and a threshold distance from the vehicle.

10. The method of claim 1, wherein the at least one nearby vehicle comprises another vehicle within a threshold distance of the vehicle or within an area surrounding the vehicle.

11. A non-transitory computer-readable storage medium storing instructions that, when executed by a processor, cause the processor to perform the method of claim 1.

12. A traveling route changing apparatus, comprising:
a sensor configured to detect at least one nearby vehicle located around a vehicle; and
a processor configured to
extract an emergency vehicle among the at least one nearby vehicle; and
determine whether to change a traveling route of the vehicle based on a movement of the emergency vehicle.

13. The apparatus of claim 12, wherein the processor is further configured to:
generate candidate routes for the vehicle to travel based on the movement of the at least one nearby vehicle, in response to a determination to change the traveling route;
estimate, for each of the candidate routes, a collision probability of the vehicle colliding with the at least one nearby vehicle; and
select one of the candidate routes, having a lowest collision probability, to be a new traveling route of the vehicle.

14. The apparatus of claim 13, wherein the candidate routes comprise a candidate route allowing the vehicle to move towards a border line of a lane on which the vehicle is travelling without changing to another lane.

15. The apparatus of claim 13, wherein the processor is further configured to control the vehicle to travel along the selected traveling route.

16. The apparatus of claim 12, wherein the processor is further configured to generate a local map indicating a location of each of the at least one nearby vehicle and the vehicle, and a size of the local map is determined based on a speed of the vehicle.

17. A traveling route changing method, comprising:
generating candidate routes for a vehicle to travel based on a movement of at least one nearby vehicle located around the vehicle;
estimating, for each of the candidate routes, a collision probability of the vehicle colliding with the at least one nearby vehicle; and
selecting one of the candidate routes to be a traveling route of the vehicle based on the collision probability of each of the candidate routes,
wherein the candidate routes are generated based on a movement of an emergency vehicle located behind the vehicle among the at least one nearby vehicle.

18. The method of claim 17, wherein the generating of the candidate routes comprises:
generating a candidate route to not obstruct the movement of the emergency vehicle.

19. The method of claim 17, further comprising:
extracting the emergency vehicle among the at least one nearby vehicle based on any one or any combination of a type of a light source in the at least one nearby vehicle or whether the light source is activated.

20. The method of claim 17, wherein the estimating of the collision probability comprises:
determining a distance between the vehicle and the at least one nearby vehicle, in response to the vehicle travelling along a candidate route among the candidate routes.

21. The method of claim 17, wherein the estimating of the collision probability comprises:
determining a time to collision (TTC) between the vehicle and the at least one nearby vehicle, in response to the vehicle travelling along a candidate route among the candidate routes.

22. The method of claim 17, further comprising:
generating the candidate routes, in response to the emergency vehicle being located behind the vehicle and approaching the vehicle at a speed greater than or equal to a preset relative speed.

23. A route changing apparatus comprising:
sensors configured to detect at least one nearby vehicle located around a vehicle;
a head-up display (HUD);
a memory configured to store map information and instructions; and
a processor configured to execute the instructions to
extract an emergency vehicle among the at least one nearby vehicle,
determine whether to change a route of the vehicle, in response to a movement of the emergency vehicle,
generate candidate routes for the vehicle, in response to a determination to change the route,
estimate, for each of the candidate routes, a collision probability of the vehicle with the at least one nearby vehicle,
select a candidate route having a lowest collision probability, from among the candidate routes, to be a new route for the vehicle, and
output the new route through the HUD.

24. The apparatus of claim 23, wherein the sensors comprises any one or any combination of global positioning system (GPS) sensor, image sensor, sound sensor, a light sensor, a radio detection and ranging (RADAR) sensor, a light detection and ranging (LiDAR or LADAR) sensor, and a sound navigation and ranging (SONAR) sensor.

25. The apparatus of claim 23, wherein:
the processor is further configured to generate a local map indicating a location of each of the at least one nearby vehicle and the vehicle; and
the memory is further configured to store the local map and information associated with the route;
wherein the information associated with the route comprises any one or any combination of a road condition, a speed limit for the road, a number of lanes on the road, a speed limit on each lane of the lanes, a restriction on a type of a vehicle for the each lane, whether the each lane is controlled access, and whether the each lane is congested.
